(19) United States
(12) Patent Application Publication
(10) Pub. No.: US 2013/0332029 A1
(43) Pub. Date: Dec. 12, 2013

(54) METHOD AND APPARATUS FOR CONTROLLING FAILURE OF MOTOR-DRIVEN POWER STEERING SYSTEM

(71) Applicants: HYUNDAI MOTOR COMPANY, Seoul (KR); KIA MOTORS CORP., Seoul (KR)

(72) Inventors: Min Jung Kim, Hwaseong-si (KR); Sung Shik Cho, Hwaseong-si (KR); Se II Kim, Suwon-si (KR); Juhn Sub Whang, Yongin-si (KR); Mi Hoi Koo, Suwon-si (KR); Byung Ho Jun, Suwon-si (KR)

(73) Assignees: Hyundai Motor Company, Seoul (KR); Hyundai Mobis Co., Ltd., Seoul (KR); Kia Motors Corp., Seoul (KR)

(21) Appl. No.: 13/675,602

(22) Filed: Nov. 13, 2012

(30) Foreign Application Priority Data
Jun. 8, 2012 (KR) 10-2012-0061562

(51) Int. Cl. B62D 6/00

(52) U.S. Cl. CPC B62D 6/00
USPC 701/41

(57) ABSTRACT

A method and apparatus of controlling failure of a Motor-Driven Power Steering (MDPS) system may include monitoring a first torque sensor signal and a second torque sensor signal detected by a torque sensor, performing a safety mode operation in which control of the MDPS may be performed such that when a fault signal of the first torque sensor signal or the second torque sensor signal may be detected, the MDPS may be controlled to decrease a steering assist power, and performing a manual mode operation in which control of the MDPS may be performed such that when a fault signal of a remaining torque sensor signal out of the first and second torque sensor signals, which was not detected during the safety mode operation, may be detected, the MDPS may be controlled to completely lose the steering assist power.

### CROSS-REFERENCE TO RELATED APPLICATION

The present application claims priority to Korean Patent Application No. 10-2012-0061562, filed on Jun. 8, 2012, the entire contents of which is incorporated herein for all purposes by this reference.

### BACKGROUND OF THE INVENTION

1. Field of the Invention

The present invention relates to a method and apparatus for controlling failure of a motor-driven power steering system, which determine the decrease degree of steering assist power according to the type of failure of a torque sensor, and ensure steering safety and the stability of the behavior of a vehicle.

2. Description of Related Art

A torque sensor is a device for converting the torque of a steering wheel, generated by the steering intention of a driver, into an electrical signal using a torque sensor system (a torsion bar or a torque sensor). Such a torque sensor is installed in a power steering system such as a Motor-Driven Power Steering (MDPS) system and is used to measure the torque of the steering wheel.

In an existing MDPS system, the safest solution to use in a core scheme for the fail-safe of a system is to switch the mode over to manual mode wherein steering assist power, provided by the MDPS system when a signal fault and a failure occur in the system, is absolutely lost. That is, when the fault signal of a torque sensor signal is detected, the MDPS system determines the detected fault signal to be a failure signal, so that steering assist power is eliminated, and a motor and a high-current circuit are cut off, thus enabling the MDPS system to be switched so that the vehicle is steered only by the steering intention of the driver.

However, when the operation of the MDPS system is switched to manual mode as described above, the stability of steering by the driver is deteriorated while steering assist power is instantaneously lost. In particular, in the case of low-speed driving, there is a problem in that as the steering assist power is lost, the steering power of the driver is suddenly increased, and thus the risk of an accident is increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method and apparatus for controlling the failure of a motor-driven power steering system, which determine the degree of control over steering assist power according to the type of failure of a torque sensor, so that the overall safety of steering is improved and the stability of the behavior of a vehicle is ensured, thus protecting a driver as well as the operation of the power steering system.

In an aspect of the present invention, a method of controlling failure of a Motor-Driven Power Steering (MDPS) system, may include monitoring a first torque sensor signal and a second torque sensor signal detected by a torque sensor, performing a safety mode operation in which control of the MDPS is performed such that when a fault signal of the first torque sensor signal or the second torque sensor signal is detected, the MDPS is controlled to decrease a steering assist power, and performing a manual mode operation in which control of the MDPS is performed such that when a fault signal of a remaining torque sensor signal out of the first and second torque sensor signals, which was not detected during the safety mode operation, is detected, the MDPS is controlled to completely lose the steering assist power.

In the performing the safety mode operation and the performing the manual mode operation, a reference voltage used by the torque sensor is compared with the first torque sensor signal and the second torque sensor signal, and the fault signal is detected when a corresponding torque sensor signal falls outside a normal voltage section in the reference voltage used by the torque sensor.

The reference voltage is 5 V and the normal voltage section is between 0.5 and 4 V.

The performing the safety mode operation is configured to perform control of the MDPS such that steering assist power being in a normal state is decreased to half.

The monitoring the first and second torque sensor signals may further include monitoring a fault signal of a reference voltage used by the torque sensor and performing control of the MDPS such that when the fault signal of the reference voltage is detected, the manual mode operation is performed.

The monitoring the first and second torque sensor signals is configured to perform control of the MDPS such that when fault signals of the first torque sensor signal and the second torque sensor signal are simultaneously detected, the manual mode operation is performed.

In another aspect of the present invention, an apparatus for controlling failure of a Motor-Driven Power Steering (MDPS) system, may include a control unit for monitoring a first torque sensor signal and a second torque sensor signal detected by a torque sensor, and performing control of the MDPS such that when a fault signal of the first torque sensor signal or the second torque sensor signal is detected, steering assist power is decreased, and such that when a fault signal of a remaining torque sensor signal out of the first and second torque sensor signals, which was not detected, is detected, the MDPS is controlled to lose the steering assist power completely.

A reference voltage used by the torque sensor is compared with the first torque sensor signal and the second torque sensor signal, and the fault signal is detected when a corresponding torque sensor signal falls outside a normal voltage section in the reference voltage used by the torque sensor.

The reference voltage is 5 V and the normal voltage section is between 0.5 and 4 V.

When a fault signal of the reference voltage is detected, the manual mode operation is performed

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating the indication of torque sensor signals when a torque sensor is operating normally according to an exemplary embodiment of the present invention.

FIG. 2 is a diagram illustrating the detection of a fault signal of a torque sensor signal and the operation modes of an MDPS system depending on the type of failure when failure of a torque sensor is determined according to an exemplary embodiment of the present invention.

FIG. 3 is a flowchart showing a method of controlling failure of an MDPS system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the attached drawings.

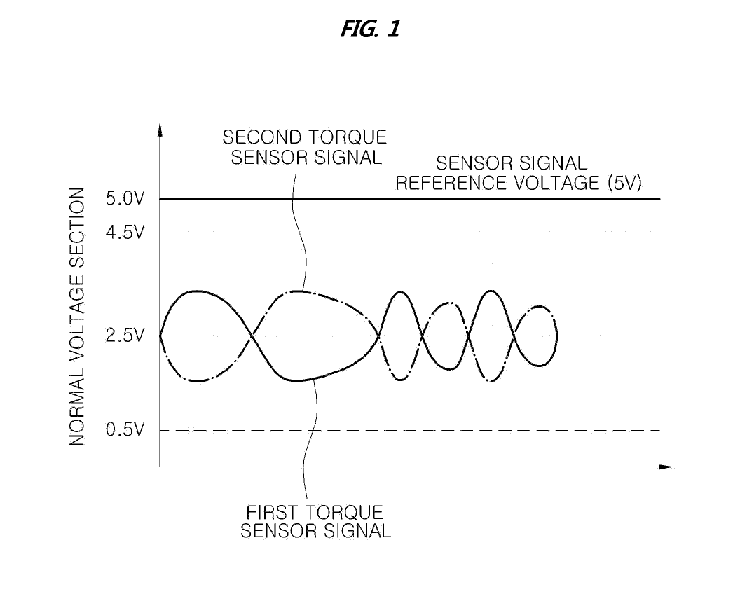

A method of controlling failure of a Motor-Driven Power Steering (MDPS) system according to the present invention shown in FIGS. 1 to 3 includes a fault signal monitoring step of monitoring fault signals of a first torque sensor signal and a second torque sensor signal which are detected by a torque sensor; a safety mode operation step of performing control such that if a fault signal of the first torque sensor signal or the second torque sensor signal is detected, steering assist power is decreased; and a manual mode operation step of performing control such that if a fault signal of the remaining torque sensor signal, which was not yet detected, is detected during the safety mode operation, the steering assist power is completely lost.

That is, when fault signals of the first torque sensor signal and the second torque sensor signal are monitored, and any one of the first and second torque sensor signals is detected as a fault signal, the MDPS system is operated in safety mode in which control is performed such that steering assist power provided by the MDPS system is decreased to a predetermined level. Further, during the operation of the MDPS system in safety mode, if a fault signal of the remaining torque sensor signal is detected, the MDPS system is operated in manual mode in which control is performed such that the steering assist power provided by the MDPS system is completely lost.

Therefore, if failure of the torque sensor is determined, the mode of the MDPS system is not immediately switched to manual mode and can be switched from safety mode to manual mode according to the type of failure, thus solving the instability of a vehicle behavior and steering instability caused by the in stantaneous loss of the steering assist power.

Here, the MDPS system used in the present invention may be designed to generate two signals, that is, a first torque sensor signal and a second torque sensor signal (a reference signal and a redundancy signal) according to system design specifications based on the importance of torque signals and to transmit the signals to a control unit.

For this, two hall Integrated Circuits (ICs) may be used to recognize the torque of the torque sensor. A fault signal of the first torque sensor signal or the second torque sensor signal can be generated in a situation in which any one of the two hall ICs has failed in the torque sensor.

At the safety mode operation step and the manual mode operation step of the present invention, the reference voltage used by the torque sensor is compared with the first torque sensor signal and the second torque sensor signal. Accordingly, control is performed such that if a corresponding torque sensor signal falls outside a normal voltage section for the reference voltage used by the torque sensor, a fault signal is detected.

Here, the reference voltage used by the torque sensor must be detectable by the control unit and may preferably be 5V. Therefore, the first torque sensor sign a1 and the second torque sensor signal must be detected in the range of the reference voltage used by the torque sensor. Each of the torque sensor signals must have a normal voltage section in which a torque sensor signal is indicated when the torque sensor is operating normally and a fault voltage section in which a fault signal is indicated when the torque sensor fails so as to detect a fault in each torque sensor signal. For example, in the present invention, a range of 0.5 to 4.5V may be set as the normal voltage section, and the remaining range of 0.5V falling outside this normal voltage section may be set as the fault voltage section.

That is, when the first torque sensor signal or the second torque sensor signal falls outside the normal voltage section with respect to the reference voltage used by the torque sensor, this signal is determined to be a fault signal. Here, in order to detect fault signals of the first torque sensor signal and the second torque sensor signal by comparing the torque sensor signals with the reference voltage, it is assumed that the reference voltage is in a normal (steady) state.

In the present invention, at the safety mode operation step, control may be performed such that steering assist power in the normal state is decreased to half. That is, when a fault signal of the first torque sensor signal or the second torque sensor signal is detected, the operation mode is switched to safety mode, so that control is performed such that the steering assist power is decreased to half of the steering assist power being in the normal state. Accordingly, the sudden loss of the steering assist power is prevented, thus allowing the driver to easily ascertain whether a fault has occurred in the MDPS system while resolving the steering instability.

In the present invention, the fault signal monitoring step may further include a reference voltage monitoring step of monitoring a fault signal of the reference voltage used by the torque sensor, and performing control such that if a fault signal of the reference signal is detected, the MDPS system is operated in manual mode.

That is, a determination of whether a fault has occurred in the reference voltage used by the torque sensor is made together with a determination of whether a fault has occurred in the first or second torque sensor signal, by continuously monitoring the reference voltage together with the first and second torque sensor signals. Accordingly, if it is determined that the reference voltage used by the torque sensor is faulty, the mode of the MDPS system is immediately switched to manual mode regardless of whether a fault has occurred in the first torque sensor signal and the second torque sensor signal.

In the present invention, at the fault signal monitoring step, when fault signals of the first torque sensor signal and the second torque sensor signal are simultaneously detected, control may be performed such that the MDPS system is operated in manual mode. That is, when fault signals for the first torque sensor signal and the second torque sensor signal are simultaneously detected, the mode of the MDPS system is immediately switched to manual mode.

Meanwhile, the present invention may include a control unit for monitoring fault signals of the first torque sensor signal and the second torque sensor signal which are detected by the torque sensor, and performing control such that if a fault signal of the first torque sensor signal or the second torque sensor signal is detected, steering assist power is decreased, and such that if, in this state, a fault signal of the remaining torque sensor signal which was not yet detected is detected, the steering assist power is completely lost.

Here, the control unit may be an Electronic Control Unit (ECU), which may control the MDPS system by detecting, comparing, and determining electrical signals provided by the torque sensor.

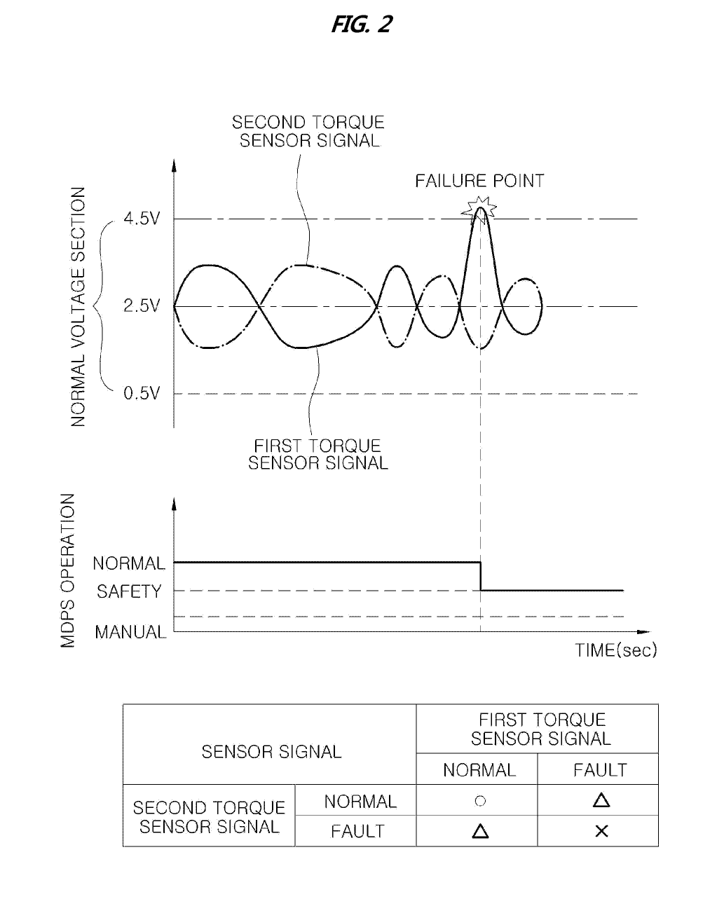

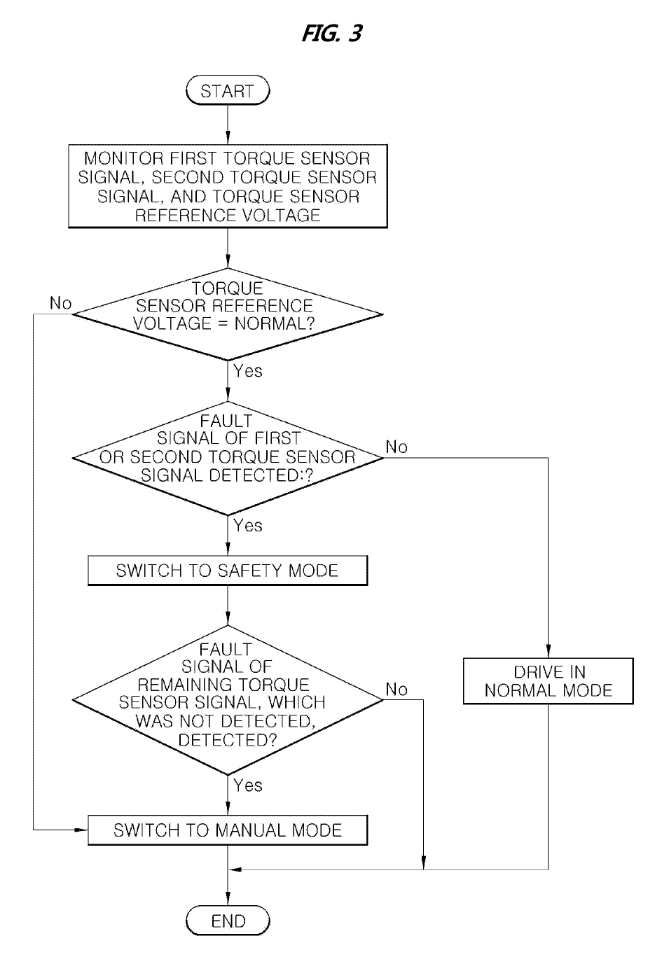

The operations and effects of the present invention will be described in detail with reference to FIGS. 2 and 3.

A signal output from the torque sensor depending on the steering intention of a driver is transmitted to the control unit, and the control unit periodically monitors a signal of the reference voltage used by the torque sensor, together with the first torque sensor signal and the second torque sensor signal which are output from the torque sensor.

During the procedure of monitoring, if a fault signal is detected for the signal of the reference voltage used by the torque sensor, it is determined that the MDPS system has failed, and the mode of the MDPS system is immediately switched to manual mode, thus causing the steering assist power to be completely lost.

However, in the case where the signal of the reference voltage used by the torque sensor is detected as a normal signal, if a fault signal, appearing when the first torque sensor signal or the second torque sensor signal falls outside the normal voltage section for the reference voltage used by the torque sensor and enters the fault voltage section, is detected, the mode of the MDPS system is switched to safety mode and then steering assist power is decreased to half.

Thereafter, if a fault signal, appearing when the remaining torque sensor signal for which a fault signal was not detected during driving in safety mode has entered the fault voltage section, is detected, it is determined that the MDPS system has failed, and the mode of the MDPS system is immediately switched to manual mode, thus causing the steering assist power to be completely lost. That is, in the state in which the fault signal is detected for the first torque sensor signal, and the mode of the MDPS system is switched to safety mode, if a fault signal is detected for the second torque sensor signal, the mode of the MDPS system is switched to manual mode.

As described above, the present invention can switch the mode of the MDPS system to safety mode in which steering assist power is reduced to a predetermined level depending on the type and degree of failure without unconditionally switching the mode of the MDPS system to manual mode when the MDPS system has failed, thus not only improving the marketability of devices, but also minimizing the instability of a driver and impact on the system caused by the sudden loss of steering power.

According to the present invention based on the technical solution, there is an advantage in that it is possible to apply a safety mode in which control is performed such that steering assist power is decreased depending on the type of fault occurring in two torque sensor signals recognized by the torque sensor, so that the occurrence of an impact on the system caused by the instantaneous loss of steering assist power is suppressed, thus improving the durability and stability of the system.

Further, there is an advantage in that steering assist power is controlled only by implementing software for signal analysis and operations without changing hardware specifications of an MDPS system, thus reducing the cost.

Furthermore, there is an advantage in that a condition in which a manual operation is performed is decreased using the operation of decreasing steering assist power in safety mode, thus improving the overall performance of the MDPS system. Furthermore, there is the advantage of reducing the costs required for After/Service (A/S) and MDPS system replacement resulting from dissatisfaction caused by temporary signal faults such as those of torque sensors, sensor parts or connectors, and the advantage of overcoming the uneasiness about the MDPS system, thus improving the productivity of vehicles.

In particular, if it is determined that a failure has occurred in an MDPS system while a vehicle is being driven, the instantaneous loss of steering assist power is prevented by switching the mode of the MDPS system to safety mode in which steering assist power is decreased to half, thus mitigating the instability of a vehicle behavior and steering, and reducing the risk of an accident.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling failure of a Motor-Driven Power Steering (MDPS) system, comprising: monitoring a first torque sensor signal and a second torque sensor signal detected by a torque sensor;
performing a safety mode operation in which control of the MDPS is performed such that when a fault signal of the first torque sensor signal or the second torque sensor signal is detected, the MDPS is controlled to decrease a steering assist power; and
performing a manual mode operation in which control of the MDPS is performed such that when a fault signal of a remaining torque sensor signal out of the first and second torque sensor signals, which was not detected during the safety mode operation, is detected, the MDPS is controlled to completely lose the steering assist power.

2. The method according to claim 1, wherein in the performing the safety mode operation and the performing the manual mode operation, a reference voltage used by the torque sensor is compared with the first torque sensor signal and the second torque sensor signal, and the fault signal is detected when a corresponding torque sensor signal falls outside a normal voltage section in the reference voltage used by the torque sensor.

3. The method according to claim 1, wherein the reference voltage is 5 V and the normal voltage section is between 0.5 and 4 V.

4. The method according to claim 1, wherein the performing the safety mode operation is configured to perform control of the MDPS such that steering assist power being in a normal state is decreased to half.

5. The method according to claim 1, wherein the monitoring the first and second torque sensor signals further includes monitoring a fault signal of a reference voltage used by the torque sensor and performing control of the MDPS such that when the fault signal of the reference voltage is detected, the manual mode operation is performed.

6. The method according to claim 1, wherein the monitoring the first and second torque sensor signals is configured to perform control of the MDPS such that when fault signals of the first torque sensor signal and the second torque sensor signal are simultaneously detected, the manual mode operation is performed.

7. An apparatus for controlling failure of a Motor-Driven Power Steering (MDPS) system, comprising:
a control unit for monitoring a first torque sensor signal and a second torque sensor signal detected by a torque sensor, and performing control of the MDPS such that when a fault signal of the first torque sensor signal or the second torque sensor signal is detected, steering assist power is decreased, and such that when a fault signal of a remaining torque sensor signal out of the first and second torque sensor signals, which was not detected, is detected, the MDPS is controlled to lose the steering assist power completely.

8. The apparatus according to claim 7, wherein a reference voltage used by the torque sensor is compared with the first torque sensor signal and the second torque sensor signal, and the fault signal is detected when a corresponding torque sensor signal falls outside a normal voltage section in the reference voltage used by the torque sensor.

9. The apparatus according to claim 8, wherein the reference voltage is 5 V and the normal voltage section is between 0.5 and 4 V.

10. The apparatus according to claim 7, wherein when a fault signal of the reference voltage is detected, the manual mode operation is performed
